(19) United States
(12) Patent Application Publication
(10) Pub. No.: US 2024/0417340 A1
(43) Pub. Date: Dec. 19, 2024

(54) METHOD FOR PREPARING POROUS CERAMIC COATED WITH METAL COATING, AND AEROSOL GENERATION APPARATUS

(71) Applicant: SHENZHEN WOODY VAPES TECHNOLOGY CO., LTD., Shenzhen, Guangdong (CN)

(72) Inventors: Yongqi HU, Shenzhen, Guangdong (CN); Huilong QI, Shenzhen, Guangdong (CN); Ge NIE, Shenzhen, Guangdong (CN); Wenzheng SONG, Shenzhen, Guangdong (CN); Junhui LI, Shenzhen, Guangdong (CN)

(73) Assignee: SHENZHEN WOODY VAPES TECHNOLOGY CO., LTD., Shenzhen, Guangdong (CN)

(21) Appl. No.: 18/714,538

(22) PCT Filed: Aug. 31, 2022
(86) PCT No.: PCT/CN2022/116117

§ 371 Date: May 29, 2024

(30) Foreign Application Priority Data
May 6, 2022 (CN) 202210487302.0

(51) Int. Cl. C04B 41/88; B01J 13/00; C04B 41/51

(52) U.S. Cl. CPC C04B 41/88; B01J 13/0095; C04B 41/5116; C04B 41/5127

(57) ABSTRACT

A method for preparing a porous ceramic covered with a metal coating, including: preparing a liquid metal slurry; soaking a porous ceramic in the liquid metal slurry for a preset time, and then taking out to obtain a porous ceramic to which the liquid metal slurry is attached; and performing drying and sintering treatments on the porous ceramic to which the liquid metal slurry is attached, so as to obtain a porous ceramic covered with a metal coating.

### TECHNICAL FIELD

The present disclosure relates to aerosol generation, and more particularly, to a method for preparing a porous ceramic coated with a metal coating and an aerosol generating apparatus.

### BACKGROUND

At present, heat generating films are generally printed on porous ceramic using a thick film printing process. However, the surface of the porous ceramic is uneven, resulting in poor bonding strength between the porous ceramic and the heat generating film. Therefore, in an actual heating process, the heat generating film may be readily warped at the corners thereof, and even fell off, thereby causing a phenomenon of dry heating of the heat generating film during the heating process and generating a burnt smell, which affects the service life of the aerosol generating apparatus and has poor stability.

### SUMMARY

Embodiments of the present disclosure provide a method for preparing a porous ceramic coated with a metal coating and an aerosol generating apparatus, which can solve the problem of poor bonding strength between the heat generating film and the porous ceramic in the prior art.

In order to solve the above technical problem, an embodiment of the present disclosure provides a method for preparing a porous ceramic coated with a metal coating, including:

preparing a liquid metal slurry;

soaking a porous ceramic in the liquid metal slurry for a preset time and then taking out the porous ceramic to obtain the porous ceramic to which the liquid metal slurry is attached; and

drying and sintering the porous ceramic to which the liquid metal slurry is attached to obtain the porous ceramic coated with the metal coating.

Further, the step of preparing the liquid metal slurry includes:

adding an organic carrier and a surfactant to a solvent, and heating in water bath to obtain an organic solution;

adding metal powder to the organic solution and stirring to obtain a premix;

subjecting the premix to an ultrasonic dispersion, and performing vacuum drying on the ultrasonic-dispersed premix to obtain the liquid metal slurry.

Further, the liquid metal slurry includes, by mass parts:

50 to 65 parts of the organic carrier;

3 to 10 parts of the surfactant;

10 to 25 parts of an organic solvent; and

10 to 35 parts of the metal powder.

Further, the step of adding the organic carrier and the surfactant to the solvent and heating in water bath includes:

adding the organic carrier and the surfactant to the solvent, and heating for 13 to 30 minutes in water bath at a temperature of 80 to 120 Celsius degrees.

Further, the step of adding the metal powder to the organic solution and stirring includes:

adding the metal powder to the organic solution and stirring for 0.8 to 2.5 hours.

Further, the step of subjecting the premix to the ultrasonic dispersion and performing vacuum drying on the ultrasonic-dispersed premix includes:

subjecting the premix to the ultrasonic dispersion for 0.4 to 2 hours, and performing vacuum drying on the ultrasonic-dispersed premix for 2 to 4 hours under a first drying condition of a drying temperature of 120 to 150 Celsius degrees and a vacuum degree of 0.0005 to 0.0015 MPa.

Further, the step of soaking the porous ceramic in the liquid metal slurry for the preset time and then taking out the porous ceramic includes:

soaking the porous ceramic in the liquid metal slurry for the preset time and then taking out the porous ceramic, and shaking for 0.4 to 3 minutes;

performing vacuum drying on the porous ceramic to which the liquid metal slurry is attached to obtain the porous ceramic to which a solid metal slurry is attached; and

sintering the porous ceramic to which the solid metal slurry is attached.

Further, the step of performing vacuum drying on the porous ceramic to which the liquid metal slurry is attached includes:

performing vacuum drying on the porous ceramic to which the liquid metal slurry is attached for 1.5 to 3 hours under a second drying condition of a drying temperature of 100 to 130 Celsius degrees and a vacuum degree of 0.0007 to 0.0016 MPa.

Further, the step of sintering the porous ceramic to which the solid metal slurry is attached includes:

sintering the porous ceramic to which the solid metal slurry is attached for 2 to 4 hours under a sintering condition at a sintering temperature of 800 to 1200 Celsius degrees.

In order to solve the above technical problem, an embodiment of the present disclosure further provides an aerosol generating apparatus, and the following solutions are used.

The aerosol generating apparatus includes a porous ceramic coated with a metal coating, the porous ceramic is prepared by a method for preparing the metal-coated porous ceramic as described above.

Compared with the prior art, the embodiments of the present disclosure mainly have the advantages that: the porous ceramic coated with the metal coating can be formed by preparing a liquid metal slurry; soaking the porous ceramic in the liquid metal slurry for a preset time and then taking out the porous ceramic to obtain the porous ceramic to which the liquid metal slurry is attached; drying and sintering the porous ceramic to which the liquid metal slurry is attached. The porous ceramic is first socked in the liquid metal slurry so that the liquid metal slurry is attached to the porous ceramic (at this time, the liquid metal slurry is not bonded to the porous ceramic), and then the porous ceramic to which the liquid metal slurry is attached is taken out, and the liquid metal slurry and the porous ceramic are bonded to form the porous ceramic coated with the metal coating by drying and sintering. After the heat generating film is formed on the porous ceramic, the heat generating film is bonded to the metal coating on the porous ceramic to form a metallurgical bonding layer, thereby effectively improving the bonding force between the heat generating film and the porous ceramic, effectively ensuring the service life and the stability of the heat generating film, and the metal coating effectively improves the thermal conductivity and the oil absorption performance of the porous ceramic, thereby effectively improving the atomization effect.

### BRIEF DESCRIPTION OF THE DRAWINGS

In order to clearly illustrate the embodiments of the present disclosure, a brief introduction to the accompanying drawings to be used in the description of the embodiments will be given below. It will be apparent that the accompanying drawings in the following description are some of the embodiments of the present disclosure, and other drawings may be made based on these drawings for those skilled in the art without involving any inventive effort.

FIG. 1 is a flowchart of a method for preparing a porous ceramic coated with a metal coating according to an embodiment of the present disclosure.

### DETAILED DESCRIPTION

Unless defined otherwise, all technical and scientific terms used herein have the same meaning as commonly understood by one of ordinary skill in the art to which present disclosure pertains. The terms used in the specification of the present disclosure herein are intended to explain specific examples only, and not limit the present disclosure. The terms “comprise”, “include” and “have”, and any variations thereof in the specification and claims of the present disclosure and in the description of the appended drawings are intended to encompass non-exclusive inclusion. The terms “first”, “second” and the like in the specification and claims of the present disclosure or in the description of the appended drawings are used to distinguish between different objects, and not to describe a particular order.

Reference herein to “an embodiment” means that a particular feature, structure, or characteristic described with reference to the embodiment may be included in at least one embodiment of the present disclosure. The appearances of the phrases in various instances in the specification are not necessarily all referring to the same embodiment, nor are they separate or alternative embodiments that are mutually exclusive of other embodiments. It will be explicitly and implicitly understood by those skilled in the art that the embodiments described herein may be combined with other embodiments.

The embodiments of the present disclosure will be described in a clear and full manner with reference to the accompanying drawing, in order to provide those skilled in the art with a better understanding of the embodiments of the present disclosure.

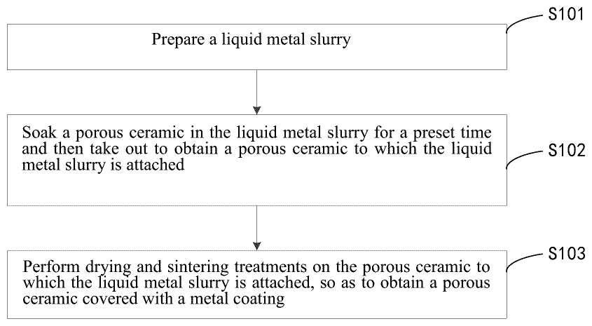

Referring to FIG. 1, it illustrates a flowchart of a method for preparing a porous ceramic coated with a metal coating according to an embodiment of the present disclosure. The method for preparing a porous ceramic coated with the metal coating comprises the following steps.

Step S101: Preparing a liquid metal slurry.

In the embodiment of the present disclosure, the liquid metal slurry may be a silver slurry, a copper slurry, or the like, provided that the liquid metal slurry can be bonded to a heat generating film to form a metallurgical bonding layer during processing. The liquid metal slurry is colloidal or viscous.

Step S102: Soaking a porous ceramic in the liquid metal slurry for a preset time and then taking out the porous ceramic, to obtain the porous ceramic to which the liquid metal slurry is attached.

In the embodiment of the present disclosure, the porous ceramic is completely socked in the liquid metal slurry so that the liquid metal slurry is sufficiently attached to the porous ceramic (at this time, the porous ceramic is not bonded to the liquid metal slurry) to obtain the porous ceramic to which the liquid metal slurry is attached, thereby ensuring the quality of the finished product.

The preset time for soaking the porous ceramic in the liquid metal slurry is related to the shape of the porous ceramic and the amount of the liquid metal slurry. Accordingly, the preset time can be determined according to previous experiments. Generally, under the premise of a certain amount of the liquid metal slurry, the larger the size of the porous ceramic is, the longer the required soaking preset time is; while under the premise of a certain amount of porous ceramic, the more the amount of the liquid metal slurry is, the shorter the required soaking preset time is.

Step S103: Drying and sintering the porous ceramic to which the liquid metal slurry is attached to obtain the porous ceramic coated with the metal coating.

In the embodiment of the present disclosure, the drying and sintering treatment includes a vacuum drying treatment and a sintering treatment (see below for details). After the drying and sintering treatment, the liquid metal slurry is bonded to the porous ceramic, and at this time, the liquid metal slurry forms a metal coating on the porous ceramic. Then, the heat generating film is disposed on the porous ceramic (for example, by a thick film printing process), and the heat generating film is bonded to the metal coating on the porous ceramic to form a metallurgical bonding layer, thereby effectively enhancing the bonding force between the heat generating film and the porous ceramic.

The porous ceramic is first socked in the liquid metal slurry so that the liquid metal slurry is attached to the porous ceramic (at this time, the liquid metal slurry is not bonded to the porous ceramic), and then the porous ceramic to which the liquid metal slurry is attached is taken out. After drying and sintering, the liquid metal slurry is bonded to the porous ceramic to form the porous ceramic coated with the metal coating. Then, the heat generating film is disposed on the porous ceramic, and the heat generating film is bonded to the metal coating on the porous ceramic to form the metallurgical bonding layer, thereby effectively improving the bonding force between the heat generating film and the porous ceramic, effectively ensuring the service life and stability of the heat generating film, and the metal coating effectively improves the thermal conductivity and the oil absorption performance of the porous ceramic, thereby effectively improving the atomization effect.

In some alternative embodiments, in step S101 above, the step of preparing the liquid metal slurry comprises the following:

adding an organic carrier and a surfactant to a solvent, and heating it in water bath to obtain an organic solution;

adding metal powder to the organic solution, and stirring it to obtain a premix;

subjecting the premix to an ultrasonic dispersion, and performing vacuum drying on the dispersed premix to obtain the liquid metal slurry.

In the embodiment of the present disclosure, the organic carrier includes at least one of polyvinyl alcohol, terpineol, tributyl citrate, and lecithin, which is not specifically limited herein.

The surfactant includes citric acid, pinolenic acid, and the like, which is not specifically limited herein.

The metal powder may be a silver powder, a copper powder, a gold powder, or other power. For example, the silver powder is a silver nanopowder that is a metallic silver simple substance having a nanometer-sized particle diameter, for example, having a particle diameter of 10 to 35 nanometers.

The solvent may be an organic solvent for dissolving the organic carrier, the surfactant, and the metal powder to achieve mixing of the organic carrier, the surfactant, and the metal powder. The organic solvent includes at least one of butyl cellosolve acetate, diethylene glycol butyl ether acetate, diethylene glycol ethyl ether acetate, isophorone, and tributyl citrate.

The heating in water bath may be performed with a magnetic stirrer to simultaneously heat and stir, thereby effectively improving the dissolution efficiency of the organic carrier and the surfactant in the solvent.

The stirring may be carried out by a machine or by manual stirring to accelerate the dissolution of the metal powder.

In the ultrasonic separation process, the dissolved nano-metal powder in the premix is separated from the solution (formed by dissolving the organic carrier and the surfactant in the organic solvent). The ultrasonic separation process can effectively improve the separation efficiency of the dissolved nano-metal powder from the solution, thereby reducing the cost.

The vacuum drying may be carried out to dry the premix, obtaining the liquid metal slurry in colloid or viscous form. Therefore, a high drying efficiency can be achieved by the vacuum drying.

In some alternative embodiments, the liquid metal slurry comprises, by mass parts:

50 to 65 parts of the organic carrier;

3 to 10 parts of the surfactant;

10 to 25 parts of an organic solvent; and

10 to 35 parts of the metal powder.

In the embodiment of the present disclosure, different mass parts of the organic carrier and the surfactant require different time for dissolving, and the proportion of the organic carrier, the surfactant, and the solvent can be set. When the large/small mass parts of the organic carrier and the surfactant are to be dissolved, the solvent in corresponding mass parts can be prepared. The relationship in mass parts of the organic carrier and the surfactant to the solvent can be determined by previous experiment.

The dissolution rate of the organic carrier and the surfactant is related to the mass parts thereof. In general, in the same mass parts of the solvent, the larger the mass parts of the organic carrier and the surfactant is, the longer the time required for heating in water bath is. On the contrary, the smaller the mass parts of the organic carrier and the surfactant is, the shorter the time required for heating in water bath is. Therefore, the reasonable time required for heating in water bath is set according to the selected solvent, the organic carrier and the surfactant, so as to ensure that the organic carrier and the surfactant can be completely dissolved in the solvent. The correspondence between the mass parts of the organic carrier and the surfactant and the time required for heating in water bath can be obtained according to previous experiments.

Different mass parts of the metal powder require different time for mixing with the organic solution, and the ratio of the metal powder to the organic solution can be set. When large/small mass parts of the metal powder is to be mixed, the corresponding mass parts of the organic solution can be provided. The relationship of mass parts of the metal powder and the organic solution can be obtained by previous experiments.

The mixing speed of the metal powder is related to the mass parts thereof. In general, in the same mass parts of the solvent, the larger the mass parts of the metal powder is, the longer the stirring time is, and the smaller the mass parts of the metal powder is, the shorter the stirring time is. Therefore, the reasonable stirring time is set according to the selected organic solution and the metal powder, so as to ensure that the metal powder can be sufficiently mixed with the organic solution. The corresponding relationship between the mass parts of the metal powder and the stirring time can be obtained from previous experiments.

In some alternative embodiments, the step of adding the organic carrier and the surfactant to the solvent and heating it in water bath comprises:

adding the organic carrier and the surfactant to the solvent, and heating for 13 to 30 minutes in water bath at a temperature of 80 to 120 Celsius degrees.

In the embodiment of the present disclosure, a magnetic stirrer, in combination with water bath at a temperature of 80 to 120 Celsius degrees, may be used to accelerate the dissolution rate of the organic carrier and the surfactant. Alternatively, stirring and heating in water bath are simultaneously performed to further increase the dissolution rate of the organic carrier and the surfactant.

It is noted that the higher water bath temperature is, the shorter the required heating time in water bath is, and the lower water bath temperature is, the longer the required heating in water bath is. The corresponding relationship between water bath temperature and the heating time in water bath can be obtained according to previous experiments.

In some alternative embodiments, the step of adding the metal powder to the organic solution and stirring comprises:

adding metal powder to the organic solution and stirred for 0.8 to 2.5 hours.

In the embodiment of the present disclosure, the dissolution rate of the metal powder is increased by means of mechanical or manual stirring.

It is to be noted that under the premise of a certain organic solution, the more the mass parts of the metal powder is, the longer the required stirring time is, and the less the mass parts of the metal powder is, the shorter the required stirring time is. The corresponding relationship between the mass parts of the metal powder and the stirring time can be obtained according to previous experiments.

In some alternative embodiments, the step of subjecting the premix to an ultrasonic dispersion and performing vacuum drying on the ultrasonic-dispersed premix comprises:

subjecting the premix to an ultrasonic dispersion for 0.4 to 2 hours, and performing vacuum drying treatment on the ultrasonic-dispersed premix for 2 to 4 hours under a first drying condition of a drying temperature of 120 to 150 Celsius degrees and a vacuum degree of 0.0005 to 0.0015 MPa.

In the embodiment of the present disclosure, the vacuum drying treatment is performed under the first drying condition of a drying temperature of 120 to 150 Celsius degrees and a vacuum degree of 0.0005 to 0.0015 MPa, to avoid deterioration of the premix during drying, and to maintain high drying efficiency.

In some alternative embodiments, the step of soaking the porous ceramic in the liquid metal slurry for a preset time and then taking out comprises:

soaking the porous ceramic in the liquid metal slurry for a preset time and then taking out the porous ceramic, and shaking for 0.4 to 3 minutes;

The step of drying and sintering the porous ceramic to which the liquid metal slurry is attached comprises:

performing vacuum drying on the porous ceramic to which the liquid metal slurry is attached to obtain a porous ceramic to which the solid metal slurry is attached; and

sintering the porous ceramic to which the solid metal slurry is attached.

In the embodiment of the present disclosure, since the porous ceramic has a plurality of through-holes (which may be small holes or fine holes), when the porous ceramic is socked in the liquid metal slurry for a preset time and then taken out, the through-holes on the porous ceramic may be filled with the liquid metal slurry. At this time, the excess liquid metal slurry in the through-holes is shook out by the shaking process, and the metal slurry is sufficiently flowed to the inner surface of the through-holes and the surface of the porous ceramic so as to ensure the finished product quality of the porous ceramic coated with the metal coating.

The liquid metal slurry is first dried by a vacuum drying process to convert the liquid metal slurry into the solid metal slurry, wherein the vacuum drying process effectively improves drying efficiency and effectively prevents deterioration of the liquid metal slurry during drying; and then, the solid metal slurry is bonded to the porous ceramic by a sintering treatment to form a porous ceramic coated with the metal coating.

In some alternative embodiments, the step of performing vacuum drying on the porous ceramic to which the liquid metal slurry is attached comprises:

performing vacuum drying on the porous ceramic to which the liquid metal slurry is attached for 1.5 to 3 hours under a second drying condition of a drying temperature of 100 to 130 Celsius degrees and a vacuum degree of 0.0007 to 0.0016 MPa.

In the embodiment of the present disclosure, the vacuum drying is performed under the second drying condition of a drying temperature of 100 to 130 Celsius degrees and a vacuum degree of 0.0007 to 0.0016 MPa, thereby effectively avoiding deterioration of the liquid metal slurry during drying, and maintaining high drying efficiency.

In some alternative embodiments, the step of sintering the porous ceramic to which the solid metal slurry is attached comprises:

sintering the porous ceramic to which the solid metal slurry is attached for 2 to 4 hours at a sintering temperature of 800 to 1200 Celsius degrees.

In the embodiment of the present disclosure, the low-temperature sintering has a low sintering temperature, which effectively saves costs, and can yield the porous ceramic coated with the liquid metal slurry with strong bonding and high stability.

In order to facilitate understanding of the present disclosure by those skilled in the art, the embodiments of the present disclosure will be described in a clear and full manner with reference to the accompanying drawings.

### Example 1

The porous ceramic coated with the metal coating of Example 1 was prepared as follows:

50 parts of the polyvinyl alcohol and 3 parts of citric acid were added to 10 parts of butyl cellosolve acetate, by mass parts, and heated in water bath at a temperature of 80 Celsius degrees for 13 minutes to obtain an organic solution;

10 parts of nano-silver powder having a particle size of 10, by mass parts, was added to the organic solution and stirred for 0.8 hour to obtain a premix;

the premix was subjected to an ultrasonic dispersion for 0.4 hours, and the ultrasonic-dispersed premix was vacuum dried under a first drying condition of a drying temperature of 120 Celsius degrees and a vacuum degree of 0.0005 MPa for 2 hours to obtain a liquid silver slurry;

a porous ceramic was soaked in the liquid silver slurry for a preset time and then taken out, and was shook for 0.4 minutes to obtain the porous ceramic to which the liquid silver slurry is attached;

the porous ceramic to which the liquid silver slurry is attached was vacuum dried under a second drying condition of a drying temperature of 100 Celsius degrees and a vacuum degree of 0.0007 MPa for 1.5 hours to obtain the porous ceramic to which the solid silver slurry is attached; and

the porous ceramic to which the solid silver slurry was attached was sintered for 2 hours at a sintering temperature of 800 Celsius degrees to obtain the porous ceramic coated with a silver coating layer having a thickness of 20 nm.

### Example 2

The porous ceramic coated with the metal coating of Example 2 was prepared as follows:

52 parts of a mixed organic carrier consisting of polyvinyl alcohol (55% of the organic carrier) and terpineol (45% of the organic carrier) and 4 parts of a mixed surfactant consisting of citric acid (50% of the surfactant) and pinolenic acid (50% of the surfactant) were added into 14 parts of a mixed organic solvent consisting of butyl cellosolve acetate (50% of the organic solvent) and diethylene glycol butyl ether acetate (50% of the organic solvent), by mass parts, and heated in water bath at a temperature of 88 Celsius degrees for 16 minutes to obtain an organic solution;

17 parts of nano-silver powder having a particle size of 12, by mass parts, was added to the organic solution and stirred for 1.1 hours to obtain a premix;

the premix was subjected to an ultrasonic dispersion for 1 hour, and the ultrasonic-dispersed premix was vacuum dried under a first drying condition of a drying temperature of 126 Celsius degrees and a vacuum degree of 0.001 MPa for 2.6 hours to obtain a liquid silver slurry;

a porous ceramic was soaked in the liquid silver slurry for a preset time and then taken out, and was shook for 1 minute to obtain the porous ceramic to which the liquid silver slurry is attached;

the porous ceramic to which the liquid silver slurry is attached was vacuum dried under a second drying condition of a drying temperature of 110 Celsius degrees and a vacuum degree of 0.001 MPa for 2 hours to obtain the porous ceramic to which the solid silver slurry is attached; and

the porous ceramic to which the solid silver slurry is attached was sintered for 2.5 hours at a sintering temperature of 900 Celsius degrees to obtain the porous ceramic coated with a silver coating layer having a thickness of 30 nm.

### Example 3

The porous ceramic coated with the metal coating of Example 3 was prepared as follows:

17 parts of nano-silver powder having a particle size of 12 nm, by mass parts, was added to the organic solution and stirred for 1.1 hours to obtain a premix;

58 parts of terpineol and 6 parts of pinolenic acid were added to 80 parts of diethylene glycol butyl ether acetate, by mass parts, and heated in water bath at a temperature of 100 Celsius degrees for 24 minutes to obtain an organic solution;

17 parts of nano-silver powder having a particle size of 12, by mass parts, was added to the organic solution and stirred for 1.6 hours to obtain a premix;

the premix was subjected to an ultrasonic dispersion for 1.3 hours, and the ultrasonic-dispersed premix was vacuum dried under a first drying condition of a drying temperature of 135 Celsius degrees and a vacuum degree of 0.001 MPa for 3 hours to obtain a liquid silver slurry;

the porous ceramic was soaked in the liquid silver slurry for a preset time and then taken out, and was shook for 1.1 minutes to obtain the porous ceramic to which the liquid silver slurry is attached;

the porous ceramic to which the liquid silver slurry is attached was vacuum dried under a second drying condition of a drying temperature of 120 Celsius degrees and a vacuum degree of 0.0012 MPa for 2.2 hours to obtain the porous ceramic to which the solid silver slurry is attached; and

The porous ceramic to which the solid silver slurry is attached was sintered for 3 hours at a sintering temperature of 1000 Celsius degrees to obtain the porous ceramic coated with a silver coating layer having a thickness of 30 nm.

### Example 4

The porous ceramic coated with the metal coating of Example 4 was prepared as follows:

61 parts of a mixed organic carrier consisting of polyvinyl alcohol (70% of the organic carrier) and terpineol (30% of the organic carrier) and 8 parts of a mixed surfactant consisting of citric acid (40% of the surfactant) and pinolenic acid (60% of the surfactant) were added to 22 parts of a mixed organic solvent consisting of butyl cellosolve acetate (50% of the organic solvent) and diethylene glycol butyl ether acetate (50% of the organic solvent), by mass parts, and heated in water bath at a temperature of 108 Celsius degrees for 28 minutes to obtain an organic solution;

30 parts of nano-silver powder having a particle size of 22, by mass parts, was added to the organic solution and stirred for 2.3 hours to obtain a premix;

the premix was subjected to an ultrasonic dispersion for 1.8 hours, and the ultrasonic-dispersed premix was vacuum dried under a first drying condition of a drying temperature of 143 Celsius degrees and a vacuum degree of 0.0013 MPa for 3.5 hours to obtain a liquid silver slurry;

a porous ceramic was soaked in the liquid silver slurry for a preset time and then taken out, and was shook for 2.3 minutes to obtain the porous ceramic to which the liquid silver slurry is attached;

the porous ceramic to which the liquid silver slurry is attached was vacuum dried under a second drying condition of a drying temperature of 127 Celsius degrees and a vacuum degree of 0.0015 MPa for 2.5 hours to obtain the porous ceramic to which the solid silver slurry is attached; and

the porous ceramic to which the solid silver slurry is attached was sintered for 3.5 hours at a sintering temperature of 1100 Celsius degrees to obtain the porous ceramic coated with a silver coating layer having a thickness of 70 nm.

### Example 5

The porous ceramic coated with the metal coating of Example 5 was prepared as follows:

65 parts of the polyvinyl alcohol and 10 parts of pinolenic acid were added to 25 parts of a mixed organic solvent consisting of butyl cellosolve acetate (50% of the organic solvent) and diethylene glycol butyl ether acetate (50% of the organic solvent), by mass parts, and heated in water bath at a temperature of 120 Celsius degrees for 30 minutes to obtain an organic solution;

35 parts of nano-silver powder having a particle size of 30, by mass parts, was added to the organic solution and stirred for 2.5 hours to obtain a premix;

the premix was subjected to an ultrasonic dispersion for 2 hours, and the ultrasonic-dispersed premix was vacuum dried under a first drying condition of a drying temperature of 150 Celsius degrees and a vacuum degree of 0.0015 MPa for 4 hours to obtain a liquid silver slurry;

a porous ceramic was soaked in the liquid silver slurry for a preset time and then taken out, and was shook for 3 minutes to obtain the porous ceramic to which the liquid silver slurry is attached;

the porous ceramic to which the liquid silver slurry is attached was vacuum dried under a second drying condition of a drying temperature of 130 Celsius degrees and a vacuum degree of 0.0016 MPa for 3 hours to obtain the porous ceramic to which the solid silver slurry is attached; and

the porous ceramic to which the solid silver slurry is attached was sintered for 4 hours at a sintering temperature of 1200 Celsius degrees to obtain the porous ceramic coated with a silver coating layer having a thickness of 100 nm.

In Comparative Examples in the following experiments, the heat generating film was printed immediately on the porous ceramic by the thick film printing technique in the prior art, in which the porous ceramic and the heat generating film were of the same type as that in Examples 1 to 5.

### Test 1: Flexural Strength Test

1. Test Samples: Samples from Examples 1 to 5 according to the present disclosure and Comparative Example.

2. Formal tests: The porous ceramic of Examples 1 to 5 and Comparative Example was prepared using diatomite-based porous ceramic having a size of 8.0*3.0*2.0 mm, a pore size of 30 μm, and a porosity of 65%, and sampled separately according to Chines standard GB/T 6569-86 to measure the flexural strength of Examples 1 to 5 and Comparative Example. The flexural strength results are shown in Table 1.

TABLE 1
Flexural Strength Results

| | Thickness of silver | Three-point flexural |
|---|---|---|
| | coating/nm | strength/MPa |
| Example 1 | 20 | 20 |
| Example 2 | 30 | 27 |
| Example 3 | 30 | 26 |
| Example 4 | 50 | 32 |
| Example 5 | 100 | 46 |
| Comparative Example | / | 10 |

As can be seen from Table 1, the flexural strength of Examples 1 to 5 is stronger than that of Comparative Example, and as the thicknesses of the silver coatings in Examples 1 to 5 increase, the flexural strength of the aerosol generating apparatus becomes stronger, effectively improving the toughness and service life of the porous ceramic coated with the metal coating according to the present disclosure. Moreover, it can be seen from Examples 2 and 3 that there is little difference in flexural strength of metal-coated porous ceramic having the same thickness of the metal coatings that are prepared from liquid silver slurries prepared in different proportions.

### Test 2: Oil Absorption Test

1. Test Samples: Samples from Examples 1 to 5 according to the present disclosure and Comparative Example.
2. Formal Test: The porous ceramic of Examples 1 to 5 and Comparative Example was prepared using diatomite-based porous ceramic (referring to the porous ceramic in Test 1 above for details). The diatomite-based porous ceramic to be measured was vertically placed in a culture dish which was horizontally placed and contained 3 mm depth of smoke oil, with the bottom surface of the diatomite-based porous ceramic as the reference surface, and the time required for smoke oil rising by 5 mm due to absorption by the diatomite-based porous ceramic (i.e., 5 mm vertically from the reference surface) was recorded as the oil absorption time. The oil absorption test results are shown in Table 1.

TABLE 2
Oil absorption test results

| | Thickness of silver | Oil absorption |
|---|---|---|
| | coating/nm | time/seconds |
| Example 1 | 20 | 48 |
| Example 2 | 30 | 30 |
| Example 3 | 30 | 32 |
| Example 4 | 50 | 27 |
| Example 5 | 100 | 18 |
| Comparative Example | / | 10 |

As can be seen from Table 2, the oil absorption time of Examples 1 to 5 is less than that of Comparative Example, indicating that the metal-coated porous ceramic according to the present disclosure has stronger oil absorption property than Comparative Example. Moreover, it can be seen from Examples 2 and 3 that there is little difference in the oil absorption property of the metal-coated porous ceramic having the same thickness of the metal coatings that are prepared from liquid silver slurries prepared in different proportions.

### Test 3: Service Life Test

1. Test Samples: Samples from Examples 1 to 5 according to the present disclosure and Comparative Example.
2. Preparation of an aerosol generating apparatus for testing: a heat generating film was printed on the metal coating of the porous ceramic coated with the metal coating prepared in Examples 1 to 5 by a thick film printing technique in the prior art.
3. Formal test: A plurality of aerosol generating apparatuses having the same basic parameters (e.g., model, power, etc.) were provided, and the aerosol generating apparatuses of Examples 1 to 5 and Comparative Example were respectively installed in each of the aerosol generating apparatuses. The heat generating films of the aerosol generating apparatuses were heated without aerosol at 6 W power, and then the aerosol generating apparatuses were subjected to cyclic suction in a way of sucking for 3 seconds and then stopping for 8 seconds, observing whether the heat generating films were detached from the porous ceramic. Service life test results are shown in Table 3.

TABLE 3
Service life Test Results

| | | Service life after |
|---|---|---|
| | Thickness of silver | heating without |
| | coating/nm | aerosol/times |
| Example 1 | 20 | 300 |
| Example 2 | 30 | 810 |
| Example 3 | 30 | 846 |
| Example 4 | 50 | 1200 |
| Example 5 | 100 | 1800 |
| Comparative Example | / | 100 |

As can be seen from Table 3, the service life after heating without aerosol of Examples 1 to 5 is much greater than that of Comparative Example, indicating that the aerosol generating apparatuses prepared with the porous ceramic coated with the metal coating according to the present disclosure have a longer use stability and service life. It can be seen from Examples 2 and 3 that there is little difference in the service life on dry heating of the metal-coated porous ceramic having the same thickness of the metal coatings that are prepared from liquid silver slurries prepared in different proportions.

In order to solve the above technical problems, an embodiment of the present disclosure further provides an aerosol generating apparatus including a metal coated porous ceramic prepared by a method for preparing the metal coated porous ceramic as described above.

The porous ceramic is first soaked in a liquid metal slurry so that the liquid metal slurry adheres to the porous ceramic (at this time, the liquid metal slurry is not bonded to the porous ceramic), and then the porous ceramic to which the liquid metal slurry adheres is taken out, and subjected to dry sintering to bond the liquid metal slurry to the porous ceramic to form a porous ceramic coated with the metal coating. Thus, when the heat generating film is formed on the porous ceramic by a thick film printing process, the heat generating film is bonded to the metal coating on the porous ceramic to form a metallurgical bonding layer, thereby effectively improving the bonding force between the heat generating film and the porous ceramic, effectively ensuring the service life and the use stability of the heat generating film, and the metal coating effectively improves the thermal conductivity and the oil absorption performance of the porous ceramic, thereby effectively improving the atomization effect.

It is apparent that the described embodiments above are merely a part of the embodiments of the present disclosure and not all of the embodiments. Preferred embodiments of the present disclosure are given in the accompanying drawings, but do not limit the scope of the present disclosure. The present disclosure may be implemented in many different forms, but rather, these embodiments are provided for a thorough understanding of the disclosure of the present disclosure. Although the present disclosure has been described in detail with reference to the foregoing embodiments, it will be apparent to those skilled in the art that modifications may be made to the technical solutions described in the foregoing embodiments, or equivalents substitutions may be made to some of the technical features thereof. Any equivalent structure made by utilizing the contents of the specification and the accompanying drawings of the present disclosure, which is directly or indirectly applied in other related technical fields, is similarly within the scope of the patent application.

1. A method for preparing a porous ceramic coated with a metal coating, comprising:
preparing a liquid metal slurry, wherein the liquid metal slurry comprises, by mass parts, 50 to 65 parts of an organic carrier; 3 to 10 parts of a surfactant; 10 to 25 parts of an organic solvent; and 10 to 35 parts of a metal powder, and the metal powder is selected from one of a silver powder, a copper powder, or a gold powder;
soaking a porous ceramic in the liquid metal slurry for a preset time and then taking out the porous ceramic to obtain the porous ceramic to which the liquid metal slurry is attached; and
drying and sintering the porous ceramic to which the liquid metal slurry is attached to obtain the porous ceramic coated with the metal coating; and
preparing a heat generating film on the metal coating by a thick film printing process, wherein the heat generating film is bonded to the metal coating to form a metallurgical bonding layer,
wherein the soaking the porous ceramic in the liquid metal slurry for the preset time and then taking out the porous ceramic comprises:
soaking the porous ceramic in the liquid metal slurry for the preset time and then taking out the porous ceramic, and shaking for 0.4 to 3 minutes.

2. The method for preparing the porous ceramic coated with the metal coating according to claim 1, wherein the preparing the liquid metal slurry comprises:
adding the organic carrier and the surfactant to the solvent, and heating in water bath to obtain an organic solution;
adding the metal powder to the organic solution and stirring to obtain a premix;
subjecting the premix to an ultrasonic dispersion, and performing vacuum drying on the ultrasonic-dispersed premix to obtain the liquid metal slurry.

3. (canceled)

4. The method for preparing the porous ceramic coated with the metal coating according to claim 2, wherein the adding the organic carrier and the surfactant to the solvent and heating in water bath comprises:
adding the organic carrier and the surfactant to the solvent, and heating for 13 to 30 minutes in water bath at a temperature of 80 to 120 Celsius degrees.

5. The method for preparing the porous ceramic coated with the metal coating according to claim 2, wherein the adding the metal powder to the organic solution and stirring comprises:
adding the metal powder to the organic solution and stirring for 0.8 to 2.5 hours.

6. The method for preparing the porous ceramic coated with the metal coating according to claim 2, wherein the subjecting the premix to the ultrasonic dispersion and performing vacuum drying on the ultrasonic-dispersed premix comprises:
subjecting the premix to the ultrasonic dispersion for 0.4 to 2 hours, and performing vacuum drying on the ultrasonic-dispersed premix for 2 to 4 hours under a first drying condition of a drying temperature of 120 to 150 Celsius degrees and a vacuum degree of 0.0005 to 0.0015 MPa.

7. The method for preparing the porous ceramic coated with the metal coating according to claim 1, wherein
the drying and sintering the porous ceramic to which the liquid metal slurry is attached comprises:
performing vacuum drying on the porous ceramic to which the liquid metal slurry is attached to obtain the porous ceramic to which a solid metal slurry is attached; and
sintering the porous ceramic to which the solid metal slurry is attached.

8. The method for preparing the porous ceramic coated with the metal coating according to claim 7, wherein the performing vacuum drying on the porous ceramic to which the liquid metal slurry is attached comprises:
performing vacuum drying on the porous ceramic to which the liquid metal slurry is attached for 1.5 to 3 hours under a second drying condition of a drying temperature of 100 to 130 Celsius degrees and a vacuum degree of 0.0007 to 0.0016 MPa.

9. The method for preparing the porous ceramic coated with the metal coating according to claim 7, wherein the sintering the porous ceramic to which the solid metal slurry is attached comprises:
sintering the porous ceramic to which the solid metal slurry is attached for 2 to 4 hours under a sintering condition of a sintering temperature of 800 to 1200 Celsius degrees.

10. (canceled)

11. An aerosol generating apparatus comprising a porous ceramic coated with a metal coating, wherein a method for preparing the porous ceramic coated with the metal coating comprises:
preparing a liquid metal slurry, wherein the liquid metal slurry comprises, by mass parts, 50 to 65 parts of an organic carrier; 3 to 10 parts of a surfactant; 10 to 25 parts of an organic solvent; and 10 to 35 parts of a metal powder, and the metal powder is selected from one of a silver powder, a copper powder, or a gold powder;
soaking a porous ceramic in the liquid metal slurry for a preset time and then taking out the porous ceramic to obtain the porous ceramic to which the liquid metal slurry is attached; and
drying and sintering the porous ceramic to which the liquid metal slurry is attached to obtain the porous ceramic coated with the metal coating; and
preparing a heat generating film on the metal coating by a thick film printing process, wherein the heat generating film is bonded to the metal coating to form a metallurgical bonding layer,
wherein the soaking the porous ceramic in the liquid metal slurry for the preset time and then taking out the porous ceramic comprises:
soaking the porous ceramic in the liquid metal slurry for the preset time and then taking out the porous ceramic, and shaking for 0.4 to 3 minutes.

12. The aerosol generating apparatus according to claim 11, wherein the preparing the liquid metal slurry comprises:
adding the organic carrier and the surfactant to the solvent, and heating in water bath to obtain an organic solution;
adding the metal powder to the organic solution and stirring to obtain a premix;
subjecting the premix to an ultrasonic dispersion, and performing vacuum drying on the ultrasonic-dispersed premix to obtain the liquid metal slurry.

13. (canceled)

14. The aerosol generating apparatus according to claim 12, wherein the adding the organic carrier and the surfactant to the solvent and heating in water bath comprises:
adding the organic carrier and the surfactant to the solvent, and heating for 13 to 30 minutes in water bath at a temperature of 80 to 120 Celsius degrees.

15. The aerosol generating apparatus according to claim 12, wherein the adding the metal powder to the organic solution and stirring comprises:
adding the metal powder to the organic solution and stirring for 0.8 to 2.5 hours.

16. The aerosol generating apparatus according to claim 12, wherein the subjecting the premix to the ultrasonic dispersion and performing vacuum drying on the ultrasonic-dispersed premix comprises:
subjecting the premix to the ultrasonic dispersion for 0.4 to 2 hours, and performing vacuum drying on the ultrasonic-dispersed premix for 2 to 4 hours under a first drying condition of a drying temperature of 120 to 150 Celsius degrees and a vacuum degree of 0.0005 to 0.0015 MPa.

17. The aerosol generating apparatus according to claim 11, wherein
the drying and sintering the porous ceramic to which the liquid metal slurry is attached comprises:
performing vacuum drying on the porous ceramic to which the liquid metal slurry is attached to obtain the porous ceramic to which a solid metal slurry is attached; and
sintering the porous ceramic to which the solid metal slurry is attached.

18. The aerosol generating apparatus according to claim 17, wherein the performing vacuum drying on the porous ceramic to which the liquid metal slurry is attached comprises:
performing vacuum drying on the porous ceramic to which the liquid metal slurry is attached for 1.5 to 3 hours under a second drying condition of a drying temperature of 100 to 130 Celsius degrees and a vacuum degree of 0.0007 to 0.0016 MPa.

19. The aerosol generating apparatus according to claim 17, wherein the sintering the porous ceramic to which the solid metal slurry is attached comprises:
sintering the porous ceramic to which the solid metal slurry is attached for 2 to 4 hours under a sintering condition of a sintering temperature of 800 to 1200 Celsius degrees.

20. (canceled)
